(19) United States
(12) Patent Application Publication
(10) Pub. No.: US 2015/0010808 A1
(43) Pub. Date: Jan. 8, 2015

(54) BUS BAR MODULE AND POWER UNIT

(71) Applicant: Yazaki Corporation, Tokyo (JP)

(72) Inventor: Takao Shoji, Kakegawa-shi (JP)

(21) Appl. No.: 14/318,947

(22) Filed: Jun. 30, 2014

(30) Foreign Application Priority Data
Jul. 3, 2013 (JP) 2013-139835

(51) Int. Cl. H01M 2/20

(52) U.S. Cl. CPC H01M 2/206
USPC 429/158; 361/637

(57) ABSTRACT

Disclosed is a bus bar module and a power, the bus bar module includes: a plurality of bus bars for connecting a plurality of batteries in series by connecting together electrodes of the adjacent batteries of the plurality of batteries arranged straight; a plurality of terminals configured to be connected to each of the bus bars; and a case housing the plurality of bus bars and the plurality of terminals, an electronic component mounted on the batteries, the case includes: a plurality of housings arranged along an arranging direction of the plurality of batteries, housing each of the bus bars and each of the terminals; and a wiring section arranged in parallel with the plurality of housings, wiring a first electric wire configured to be connected to the terminals, the electronic component is disposed at an opposite side of the wiring section across the housing.

### CROSS REFERENCE TO RELATED APPLICATIONS

This application is on the basis of Japanese Patent Application No. 2013-139835, the contents of which are hereby incorporated by reference.

### TECHNICAL FIELD

The present invention relates to bus bar modules and power units, in particular, bus bar modules for connecting a plurality of batteries in series, and power units having the bus bar modules.

### BACKGROUND ART

For example, a battery module as a driving source of an electric vehicle is mounted on the electric vehicle running with an electric motor, and a hybrid vehicle running with both an engine and the electric motor (for example, see PTL 1).

As shown in FIG. 5, a power source 100 described in PTL 1 includes a plurality of plate-like batteries composing a battery (not shown), and a bus bar module 101 mounted on a top of a battery cell near an electrode, and the bus bar module 101 includes an insulating-resin-made lower case 104 in which a conductive metal bus bar 102 and a thermistor 103 (sensor parts) for detecting temperature, and an insulating-resin-made cover (not shown) mounted upside the case 104.

As shown in FIG. 5, the case 104 is provided with a plurality of rectangular-frame-like bus bar housings 105, a voltage detection electric wire housing 107 coupled to a front side of the bus bar housing 105 through a thin elastic wall part 106, a thermistor 108 integrally continuous with a rear side of the bus bar housing 105, and a horizontally long strip-shaped thermistor electric wire housing 109 continuous with a rear side of the thermistor housing 108. Herein a back and forth direction X in FIG. 5 is a direction crossing a parallel direction of the battery, showing a direction along a vertical direction toward this figure.

### CITATION LIST

### Patent Literature

PTL 1: JP, A, 2011-60675

### SUMMARY OF INVENTION

### Technical Problem

However, since in the conventional power unit 100 the bus bar module 101 is made such that the voltage detection electric wire housing 107 and the thermistor electric wire housing 109 are arranged in parallel in the direction X (a width direction of the bus bar module 101) perpendicular to a parallel direction of the battery cell, there has been a problem that the bus bar module 101 becomes upsized in its width direction.

Accordingly, an object of the present invention is to provide a bus bar module and a power unit allowing for downsizing.

### Solution to Problem

For attaining the object, according to a first aspect of the present invention, there is provided a bus bar module comprising: a plurality of bus bars for connecting a plurality of batteries in series by connecting together electrodes of the adjacent batteries of the plurality of batteries arranged straight; a plurality of terminals configured to be connected to each of the bus bars; and a case housing the plurality of bus bars and the plurality of terminals, an electronic component mounted on the batteries, wherein the case includes: a plurality of housings arranged along an arranging direction of the plurality of batteries, housing each of the bus bars and each of the terminals; and a wiring section arranged in parallel with the plurality of housings, wiring a first electric wire configured to be connected to the terminals, wherein the electronic component is disposed at an opposite side of the wiring section across the housing, wherein a second electric wire is configured to be connected to the electronic component, one end of the second electric wire being connected to the electronic component, the other end of the second electric wire, insulated from the electronic component being wired to the wiring section.

According to a second aspect of the present invention, there is provided the bus bar module as described in the first aspect, wherein the case is provided with a cover covering openings of the wiring section and the housing, wherein the cover is rotatively coupled with a circumferential edge of the wiring section, and is fixed to the electronic component, wherein a rotation of the cover allows the openings of the wiring section and the housing to be covered, and the electronic component to be arranged in the batteries.

According to a third aspect of the present invention, there is provided the bus bar module as described in the first or second aspect, the wiring section is arranged outward farther than the housing in a direction crossing the arranging direction, and wherein a temperature sensor as the electronic component is located inward nearer than the housing in the direction crossing the arranging direction.

According to a fourth aspect of the present invention, there is provided a power unit comprising: a battery assembly composed of a plurality of batteries of which positive electrodes and negative electrodes are alternately and oppositely overlapped with each other; and the bus bar module as described in any one of the first to third aspects.

### Advantageous Effects of Invention

According to the invention described in the first and fourth aspects, since the case includes: the plurality of housings arranged along the arranging direction of the plurality of batteries, housing each of the bus bars and each of the terminals; and the wiring section arranged in parallel with the plurality of housings, wiring the first electric wire configured to be connected to the terminals, wherein the electronic component is disposed at the opposite side of the wiring section across the housing, wherein the second electric wire is configured to be connected to the electronic component, one end of the second electric wire being connected to the electronic component, the other end of the second electric wire, insulated from the electronic component being wired to the wiring section, there is no need to provide a thermistor electric wire housing housing an electric wire connected to the thermistor as required for a convention technology, allowing for downsizing in a direction in which the housing, the wiring section and the electronic component are arranged, that is, a width direction of the bus bar module. Also, since the second electric wire connected to the electronic component allows the other end to be wired to the wiring section, the first and the second electric wires are housed in the same wiring section, and thereby there is no need to separately provide a bundle of the plurality of first electric wires connected to the terminal and a bundle of the second electric wires connected to the electronic component, allowing for bundling together the first electric wires and the second electric wires. It follows from this that the number of parts on assembling is reduced, and thereby the first and the second electric wires are made to be simultaneously wired to the wiring section, eliminating each wiring the first and the second electric wires, which improves wiring workability. Namely, it is made possible to downsize the width direction of the bus bar module, and also provide the bus bar module improving wiring workability

According to the invention described in the second aspect, since the case is provided with the cover covering openings of the wiring section and the housing, wherein the cover is rotatively coupled with the circumferential edge of the wiring section, and is fixed to the electronic component, wherein the rotation of the cover allows the openings of the wiring section and the housing to be covered, and the electronic component to be arranged in the batteries, easy work of only rotating the cover allows the electronic component such as temperature sensor to be installed on an optimal detecting face of the battery. Namely, it is made possible to improve workability for attaching the electronic component to the battery, and also provide the electronic component to an optimal site of the battery.

According to the invention described in the second aspect, the wiring section is arranged outward farther than the housing in a direction crossing the arranging direction, and wherein a temperature sensor as the electronic component is located inward nearer than the housing in the direction crossing the arranging direction. Herein, between the bus bar module and the upper face of the plurality of batteries connected in series heat may stay at the center (high temperature site) between electrodes of each battery, and as conventional technology, when the thermistor electric wire housing is disposed adjacent to the thermistor required for setting at a high temperature site, the thermistor electric wire is disposed on the high temperature site, the thermistor electric wire may be subjected to damage. Since in the invention the wiring section where the first and the second electric wires are wired is disposed outward in the direction crossing the arranging direction farther than a position where the temperature sensor is disposed as the electronic component, the wiring section is made to be disposed where the heat unlikely stays, and thereby the second electric wire connected to the temperature sensor becomes undamaged, which improves safety in light of protection of electric wire.

### BRIEF DESCRIPTION OF DRAWINGS

FIG. 1 is an exploded perspective view showing a power unit including a bus bar module according to an embodiment of the present invention;

FIG. 2 is a plan view showing a process of assembling the bus bar module shown in FIG. 1 and a state of a cover opening;

FIG. 3 is a cross-sectional view along I-I line in FIG. 2;

FIG. 4A is a view showing a frame format of a state of assembling the power unit shown in FIG. 1, and a state of a cover of the bus bar module opening;

FIG. 4B is a view showing a state after a nut being fastened;

FIG. 4C is a view showing a state of the cover of the bus bar module being closed; and

FIG. 5 is a plan view showing a conventional bus bar module.

### DESCRIPTION OF EMBODIMENTS

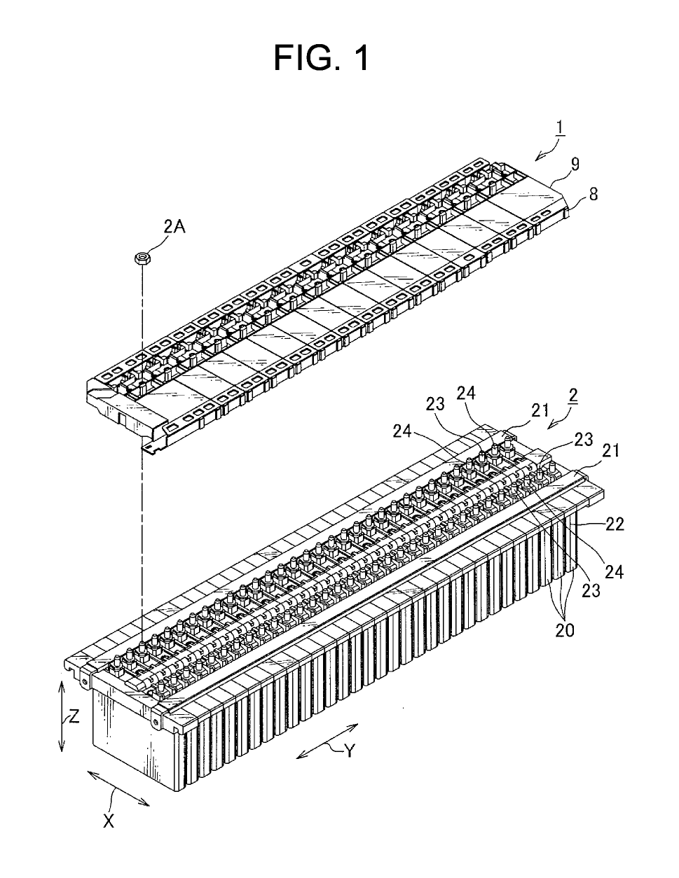

Hereinafter, a bus bar module and a power unit according to an embodiment of the present invention will be explained with reference to FIGS. 1 to 4.

As shown in FIGS. 1, a bus bar module 1 is attached to a top wall of a battery assembly 2 to form a power unit 30. This power unit 30 is mounted on an electric vehicle running with an electric motor, or a hybrid vehicle running with both an engine and the electric motor to supply electric power to the electric motor.

As shown in FIG. 1, the battery assembly 2 includes: a plurality of batteries 20; and a fixing member 21 for overlapping and fixing the plurality of batteries 20. Further, each battery 20 includes: a battery main body 22 having a boxy chassis in which an electrolyte is filled; a positive electrode 23 (an electrode) and a negative electrode 24 (an electrode) respectively projected from a top wall of the battery main body 22. Each of these positive electrodes 23 and negative electrodes 24 is made of conductive metal and formed in a cylindrical shape, and an outer periphery thereof is provided with a screw groove to be screwed with a nut 2A.

Further, in the plurality of batteries 20 the positive electrodes 23 and the negative electrodes 24 are alternately arranged in two rows so as to lie in a straight line along an overlapping direction of the batteries 20. Here, an arrow Y in FIG. 1 indicates an arranging direction of the plurality of batteries 20 and a longitudinal direction of the bus bar module 1. An arrow X indicates a direction perpendicular to the arranging direction of the batteries 20, and a width direction of the bus bar module 1. An arrow Z indicates a height direction of the bus bar module 1.

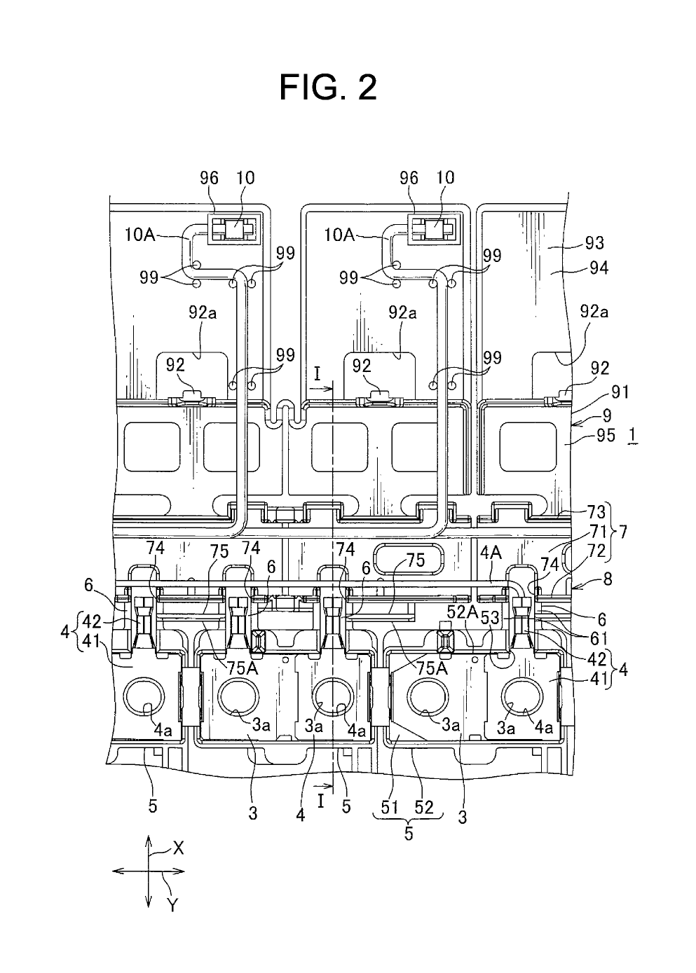

The bus bar module 1 connects the foregoing batteries 20 in series as shown in FIGS. 1 and 2, and includes, as shown in FIG. 1; a plurality of bus bars 3 for connecting the batteries 20 in series by connecting the positive electrode 23 and the negative electrode 24 of the batteries 20 adjacent to each other; a plurality of voltage detection terminals 4 (terminals) electrically connected to the bus bars 3 respectively for detecting a voltage of each battery 20; a plurality of voltage detection lines 4A connected to each of the voltage detection terminals 4; a case 8 housing these bus bars 3, the voltage detection terminals 4, and voltage detection lines 4A (first electric lines); a cover 9 disposed at the case 8 rotatively 180-degree around the arrow Y direction, covering a top face of the case 8; a plurality of temperature sensors (electronic component) fixed to the cover so as to be attached to the top face of the batteries 20; and a plurality of temperature detection lines 10A (second electric wires) connected to each temperature sensor 10. The bus bar module 1 is positioned at both ends of the plurality of batteries 20, a power control device is connected to the electrode with different polarity from each other, and then electric power is, via the power control, supplied to each device such as electric motor. Here in the present embodiment, as the temperature sensor 10 a thermistor is used.

The plurality of bus bars 3 is respectively made as by pressing a metal plate, and as shown in FIG. 2, in a rectangular plate-like metal plate, a pair of through holes 3a for inserting the positive electrode 23 and the negative electrode 24 adjacent to each other is formed. When the nuts 2A are respectively screwed with the positive electrode 23 and the negative electrode 24 inserted into the pair of through holes 3a, the bus bar 3 is fixed to and electrically connected to the positive electrode 23 and the negative electrode 24.

The plurality of voltage detection terminals 4 is respectively made by such pressing a metal plate, and as shown in FIG. 2, includes: a rectangular-plate-shaped electric contact section 41; and a wire connection section 42 continued to the electric contact section 41 and connecting the electric contact section 41 and the voltage detection line 4A. The electric contact section 41 is provided with a through hole 4a in the middle thereof. Each voltage detection terminal 4 has any one of the positive electrode 23 and the negative electrode 24 of the batteries 20 inserted into the through hole 4a and is overlapped with each bus bar 3, so as to be electrically connected to each bud bar 3, and is connected to the voltage detection line 4A at the electric wire contact section 42. Then each voltage detection terminal 4 is, via the voltage detection line 4A, connected to a not-shown voltage detection circuit. In FIG. 2, the voltage detection line 4A is shown as one line and the voltage detection line 4A except this one is omitted.

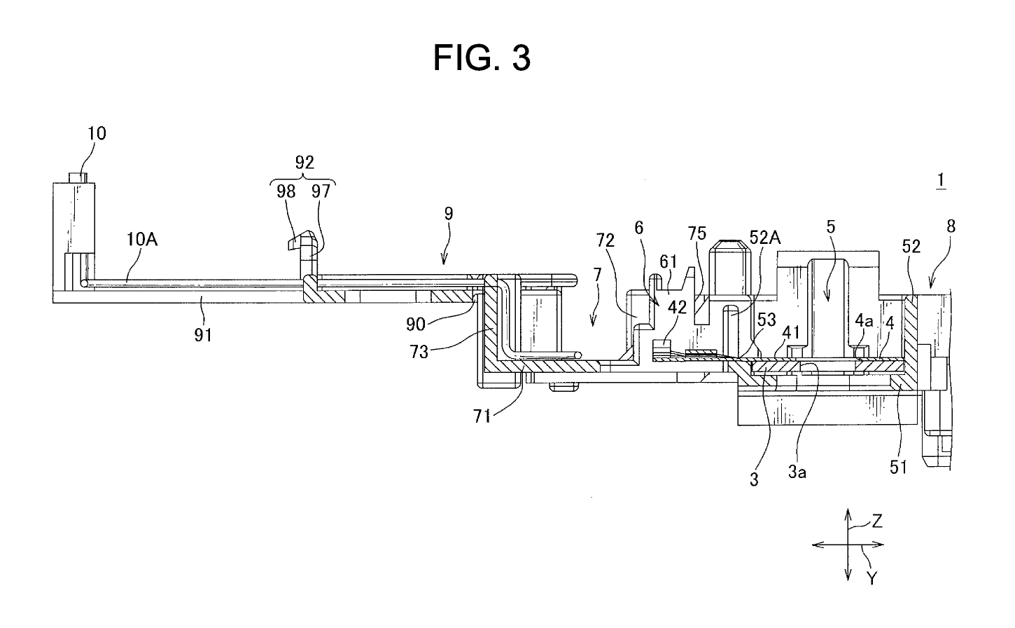

The case 8 is formed in substantially a rectangular shape similar to a top wall of the battery assembly 2, and overlapped with the top wall of the battery assembly 2. The case 8 is as shown in FIGS. 2 and 3, provided with: a plurality of bus bar housings 5 formed in a box shape able to house each bus bar 3 and the electric contact section 41 of the voltage detection terminal 4 overlapped with the bus bar 3; a gutter-shaped connection housing 6 continuing to each bus bar housing 5 and housing an electric connection section 42 of the terminal; and a gutter shaped wiring section 7 disposed in parallel on a straight line parallel to the arranging direction (the arrow Y direction) of the plurality of bus bar housings 5, and wiring the voltage detection line 4A connected to the voltage detection terminal 4 along the arranging direction of the bus bar housing 5. Herein, as shown in FIG. 1, spaced in two lines in a width direction of the bus bar module 1 is a column of the plurality of bus bar housings 5 coupled straightly, the gutter-shaped wiring section 7, and a connection housing section 6 communicating with each bus bar housing 5 and wiring section 7.

As shown in FIGS. 2, 3, the plurality of bus bar housings 5 is respectively provided with a bottom wall 51 on a surface of which the bus bar 3 and the electric contact section 41 are placed, and a side wall upstanding from a circumferential edge of the bottom wall 51 and surrounding the bus bar 3. The bottom wall 51 is disposed at the middle of the side wall 52 in the arrow Y direction, so as to place the bus bar 3. Both ends of the bottom wall 51 in the arrow Y direction open for inserting therein the electrodes 23, 24 of the batteries 20. The side wall 52 is provided with a guiding outlet 53 formed such that the side wall 52A opposed to the wiring section 7 is partially notched, and continues to the connection housing 6.

As shown in FIGS. 2 and 3, the plurality of connection housings 6 is disposed opposed to each other, and composed of a pair of side walls 61 wiring therebetween the voltage detection line 4A. In the pair of side walls 61, one end thereof is continued to both edges of the guiding outlet 53 of the bus bar housing 5, and the other thereof both edges of a guiding inlet 74 of the wiring section 7. In FIG. 3 the voltage detection line 4A is omitted.

The wiring section 7 is provided with a base wall 71 where the voltage detection line 4A, and the temperature detection line 10A connected to the temperature sensor 10 are placed, and a pair of upstanding walls 72, 73 formed upstanding from both edges of the base wall 71 in the width direction (the arrow X direction).

Of the pair of upstanding walls 72, 72 the upstanding wall 72 near the bus bar housing 5 of the bus bar module 1 in the width direction (the arrow X direction) is provided with the guiding inlet 74 (shown in FIG. 2) guiding the voltage detection line 4A guided out of the connection housing 6 into the wiring section 7, and formed such that the upstanding wall 72 is partially notched. Also, the upstanding wall 72 is provided with a latch receiving section 75 on the outside thereof, latched into a latch section 92 of a cover 9 mentioned below and keeping the cover 9 at a position where openings of the connection housing 6 and the wiring section 7 are covered. The latch receiving section 75 is disposed between the guiding inlets 74 adjacent in the length direction of the bus bar module 1 (the arrow Y direction).

The latch receiving section 75 is frame-like-shaped to pass through vertically, and a latch section 92 is configured to latch at a lower end of the wall 75A (shown in FIG. 2) opposed to the upstanding wall 72 of the side walls 75A composing the frame-like-shaped latch receiving section 75.

The cover 9 is continued to an upper edge of the bus bar housing 5 via a hinge 90 as shown in FIGS. 2, and 3. This cover 9 is formed integrally with the case 8 via the hinge 90, and formed so large as to cover just one line of the plurality of bus bar housings 5 arranged in two lines, gutter-like wiring section 7, the connection housing continued to each bus bar housing 5 and the wiring section. This cover 9 is provided with a cover body 91 formed into a plate-like shape, and a latch section 92 formed to be latched in the latch receiving section 75 of the case 8 and keeping a state in which the cover body 92 covers openings of the wiring section 7, the connection housing 6, and the bus bar housing 5 by being latched in the latch receiving section 75. The cover 9 such as this is disposed rotatively at a covering position to cover the openings of the wiring section 7, connection housing 6, and the bus bar housing 5 by the hinge deforming, and at an exposing position to expose these openings. FIG. 1 shows a state in which the cover 9 is positioned at the covering position, FIG. 2 a state in which the cover 9 is positioned at the exposing position.

The hinge 90 is formed between the upper edge of the bus bar housing 5 and a first covering section 93 covering the opening of the bus bar housing 5 integral with these bus bar housing 5 and first covering section 93. This hinge 90 is, for flexibility, formed narrower than the first covering section 93 and thin.

The cover body 91 is provided with the first covering section 93 covering the opening of bus bar housing 5, a second covering section 94 covering the opening of the connection housing 6, a third plate-like covering section 95 covering the opening of the wiring section 7, and a plate-like sensor attaching section 96 attached to the temperature sensor 10. The cover 91 is disposed where the first covering section 93, the second covering section 94, the third covering section 95, and the sensor attaching section 96 are arranged in a straight line along the width direction of the bus bar module 1.

The latch section 92 is disposed at a border between the first covering section 93 and the second covering section 94, a plate-like insertion section 97 projecting from the border between the first covering section 93 and the second covering section 94 toward inside the latch receiving section 75 while the cover 9 is positioned at the covering position, and inserted into the latch receiving section 75, and a nail section 98 projecting from a tip of the insertion section 97 and being latched in the latch receiving section 75. Also, a circumference of the latch section 92 near the second covering section 94 is thinned. The thinned section 92a (shown in FIG. 2) is formed for pulling a die when the case 8 and the cover 9 are molded integrally by injection molding.

Furthermore, the cover 9 is provided with a fixing section 99 for fixing the temperature detection line 10A connected to the temperature sensor 10 to the cover body 91. The fixing section 99 is formed in a plurality of pairs on an inner face of the cover body 91 (a face positioned inside when the cover 9 is positioned at the covering position) so as to hold therebetween the temperature detection line 10A. The fixing section 99 guides the temperature detection line 10A from the first covering section 93 to the sensor attaching section 96, and is disposed spaced from the first covering section 93 to the sensor attaching section 96.

The sensor 10 is fixed to the sensor attaching section 96 via a not-shown elastic member. The temperature sensor 10 is movably attached to the sensor attaching section 96 along a thickness direction of the cover 9. Thus, the temperature sensor 10 is, with the cover 9 positioned at the covering position, attached to a surface of the batteries 20 while elastically contacted thereto. Then each temperature sensor 10 is connected to a not-shown temperature detection circuit via the temperature detection line 10A.

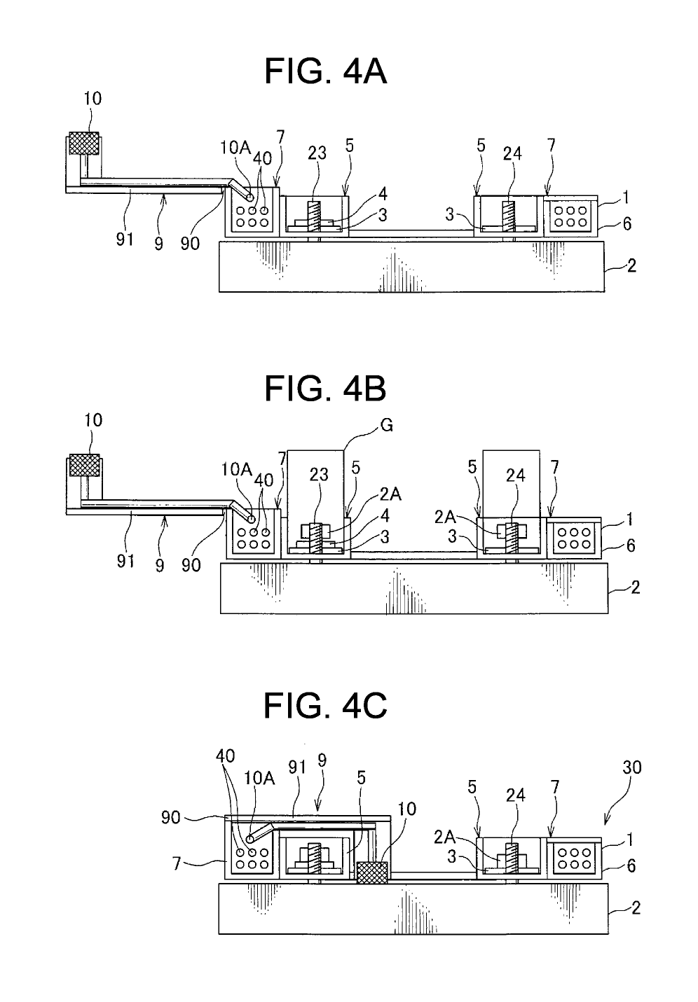

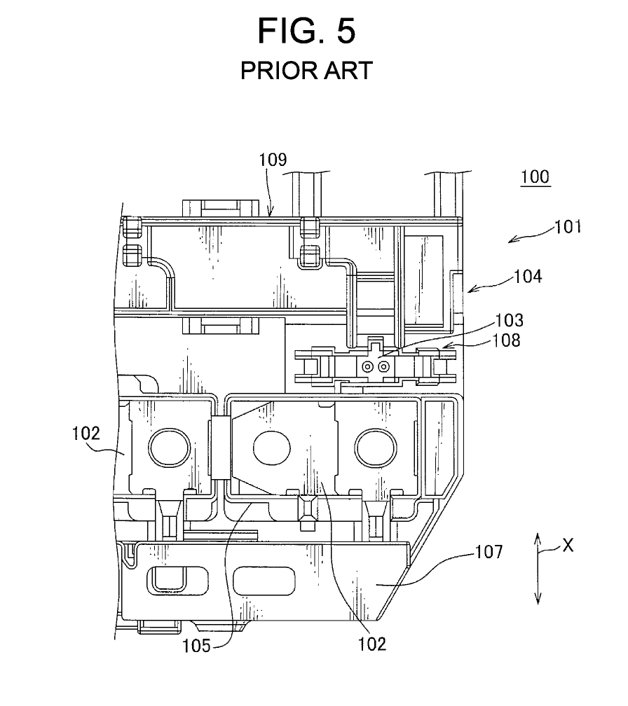

Next, an assembling procedure of the power unit 30 having the above configuration will be explained with reference to FIG. 4. First, the bus bar 3, the voltage detection terminal 4, the case 8, the cover 9, and the temperature sensor 10 and the like are separately produced. To one end of the voltage detection line 4A the electric wire connection section 42 of the voltage detection terminal 4 is connected, to one end of the temperature detection line 10A the temperature sensor 10 is connected, and the voltage detection line 4A and the temperature detection line 10A are preliminarily bundled together. The bus bar 3 is, with the cover 3 arranged in the exposing position, brought close to the bottom wall 51 of the bus bar housing 5, the electric connection contact section 41 of the voltage detection terminal 4 is brought close toward the bottom wall 51 such as to overlap with the bus bar 3, and these bus bar 3 and electric contact section 41 of the voltage detection terminal 4 are housed in the bus bar housing 5. The electric contact section 42 of the detection terminal 4 is housed in the connection housing section 6. At the same time the openings near the bottom wall 51 disposed in the bus bar housing 5 and the pair of through holes 3a disposed in the bus bar 3 are overlapped, and one of the bus bar housing 5 and the pair of the through holes 3a of the bus bar 3 is overlapped with the through hole 4a disposed in the voltage detection terminal 4. The temperature sensor 10 is also fixed to the sensor attaching section 96 via an elastic member.

Then, the other side of the voltage detection line 4A and the temperature detection line 10A are housed in the wiring section 7, one side of the voltage detection line 4A is bent to a generally right angle adjacent to a corner of the wiring section 7 and the connection housing 6. The voltage detection line 4A is thus wired in the wiring section 7. Then, the temperature detection line 10A is bent to a generally right angle adjacent to the wiring section 7 and the cover 9, the other side at a bent position is subsequently fixed to the fixing section 99 of the cover body 91. The temperature detection line 10A is thus wired in the wiring section 7. Thus, it is made possible to reduce the number of parts on assembling, and thereby to coinstantaneously wire the first electric wire and the second electric wire, eliminating wiring the voltage detection line 4A and the temperature detection line 10A respectively, so as to improve workability of wiring electric wire.

The case 8 of this state is overlapped with a top face of the battery assembly 2 (a face from which the electrodes 23, 24 projects) as shown in FIG. 4A. The electrodes 23, 24 are inserted into the through hole 3a of the bus bar 3 and the through hole 4a of the voltage detection terminal 4. Also, as shown in FIGS. 4B, the tool G for fastening the nut 2A to the electrodes 23, 24 into which the bus bar 3 and the voltage detection terminal 4 were inserted is attached to each bus bar housing 5, and using this tool G the nut 2A is fastened to the electrodes 23, 24. After that, the tool G is removed. Thus the electrodes 23, 24, the bus bar 3, and the voltage detection line 4A are connected.

Lastly, as shown in FIG. 4C, the cover 9 is rotated. The cover is positioned at the covering position, and the first, the second, and the third covering section 93, 94, 95 respectively cover openings of bus bar housing 5, the connection housing 6, and the wiring section 7, as well as the latch section 92 is latched in the latch receiving section 75. At this time the temperature sensor 10 is, with the cover 9 positioned at the covering position, attached to, and elastically contacted with, the surface of the batteries 20. Thus, an easy work of rotating the cover 9 allows the temperature sensor 10 to be installed on an optimum temperature measuring face of the batteries 20. The bus bar module 1 is thus completed and assembling the power unit 30 is finished. Although with the cover positioned at the covering positioned the temperature detection line 10A is also disposed across the bus bar housing 5 in the width direction of the bus bar module 1 (the arrow X direction), as the tool G for fastening the nut 2A is already removed, without being subject to the tool G the temperature detection line 10A can be wired.

According to the foregoing embodiment, since the temperature detection line 10A (the second electric wire) to be connected to the temperature sensor 10 (electronic component) has the other side thereof wired to the wiring section 7, the voltage detection line 4A (the first electric wire) and the temperature detection line 10A are housed in the same wiring section 7, it is unnecessary to provide a thermistor electric wire housing housing the temperature detection line 10A connected to the temperature sensor 10, downsizing the bus bar module 1 in the width direction.

Furthermore, since the wiring section 7 is disposed outward farther than the bus bar housing 5 (housing section) in the direction crossing the arranging direction (the arrow X direction), and the position where the temperature sensor 10 is attached as the electronic component is disposed inward nearer than the bus bar housing 5 in the direction crossing the arranging direction (the arrow X direction), the wiring section 7 is made to be disposed where heat unlikely stays, and thus eliminating damage of the temperature detection line 10A (the second electric wire) connected to the temperature sensor 10, which improves safety in light of protection of the electric wire.

As mentioned above, while the present invention is described taking the preferred embodiments, the present invention should not be limited to the embodiments. While in the embodiments mentioned above the temperature sensor 10 is described as one example, as the electronic component such a vibration sensor or other sensors can be adapted, or electronic components not sensors can be adapted.

Furthermore, while in the foregoing embodiments the cover 9 is coupled to the upper edge of each bus bar housing 5 via the hinge 90, the cover 9 may be formed separately from each bus bar housing 5, namely the cover 9 and the case 8 may be formed separately. In this case, the hinge may be eliminated.

Note that the foregoing embodiments each just disclose typical embodiments, but the invention should not be limited to the embodiments. Namely, it will be obvious to those skilled in the art that various changes may be made without departing from the scope of the invention. Even by such change, as long as the change is provided with the configuration of the bus bar module 1 of the present invention, of course, it is included in a category of the present invention.

Reference Signs List

1 bus bar module

30 power unit

2 battery assembly

3 bus bar

4 voltage detection terminal (terminal)

4A voltage detection line

5 bus bar housing (housing section)

7 wiring section

8 case

9 cover

10 temperature sensor

10A temperature detection line

Y arranging direction

1. A bus bar module comprising:
a plurality of bus bars for connecting a plurality of batteries in series by connecting together electrodes of the adjacent batteries of the plurality of batteries arranged straight;
a plurality of terminals configured to be connected to each of the bus bars; and
a case housing the plurality of bus bars and the plurality of terminals,
an electronic component mounted on the batteries, wherein the case includes:
a plurality of housings arranged along an arranging direction of the plurality of batteries, and housing each of the bus bars and each of the terminals; and
a wiring section arranged in parallel with the plurality of housings, and wiring a first electric wire configured to be connected to the terminals,
wherein the electronic component is disposed at an opposite side of the wiring section across the housing,
wherein a second electric wire is configured to be connected to the electronic component, one end of the second electric wire being connected to the electronic component, the other end of the second electric wire insulated from the electronic component being wired to the wiring section.

2. The bus bar module as claimed in claim 1, wherein the case is provided with a cover covering openings of the wiring section and the housing, wherein the cover is rotatively coupled with a circumferential edge of the wiring section, and is fixed to the electronic component, wherein a rotation of the cover allows the openings of the wiring section and the housing to be covered, and the electronic component to be arranged in the batteries.

3. The bus bar module as claimed in claim 1, wherein the wiring section is arranged outward farther than the housing in a direction crossing the arranging direction, and wherein a temperature sensor as the electronic component is located inward nearer than the housing in the direction crossing the arranging direction.

4. The bus bar module as claimed in claim 2, wherein the wiring section is arranged outward farther than the housing in a direction crossing the arranging direction, and wherein a temperature sensor as the electronic component is located inward nearer than the housing in the direction crossing the arranging direction.

5. A power unit comprising:
a battery assembly composed of a plurality of batteries of which positive electrodes and negative electrodes are alternately and oppositely overlapped with each other; and
the bus bar module as claimed in claim 1.

6. A power unit comprising:
a battery assembly composed of a plurality of batteries of which positive electrodes and negative electrodes are alternately and oppositely overlapped with each other; and
the bus bar module as claimed in claim 2.

7. A power unit comprising:
a battery assembly composed of a plurality of batteries of which positive electrodes and negative electrodes are alternately and oppositely overlapped with each other; and
the bus bar module as claimed in claim 3.

8. A power unit comprising:
a battery assembly composed of a plurality of batteries of which positive electrodes and negative electrodes are alternately and oppositely overlapped with each other; and
the bus bar module as claimed in claim 4.
